(19) United States
(12) Patent Application Publication
(10) Pub. No.: US 2008/0260452 A1
(43) Pub. Date: Oct. 23, 2008

(54) Writing instrument, drawing instrument and/or marking instrument and reservoir for such instruments

(76) Inventor: Susi Hafner, Nurnberg (DE)

Correspondence Address: Friedrich Kueffner, Suite 910, 317 Madison Avenue, New York, NY, 10017, US

(21) Appl. No.: 12/080,803

(22) Filed: Apr. 4, 2008

(30) Foreign Application Priority Data
Apr. 5, 2007 (DE) 10 2007 016 413.2

(51) Int. Cl. B43K 8/06

(52) U.S. Cl. 401/198; 401/292

(57) ABSTRACT

A writing instrument, drawing instrument and/or marking instrument has at least one shaft, at least the liquid reservoir mounted therein and a writing wicking, wherein between the writing wicking and the liquid reservoir at least one contact point or contact area for the conducting of the writing medium is formed. The at least one liquid reservoir has, on the side facing the writing wicking, an area with a seal, wherein the area with the sealing means covers the entire free front side of the liquid reservoir. The area with the seal is designed to be stretching at least into a partial area of the casing surface.

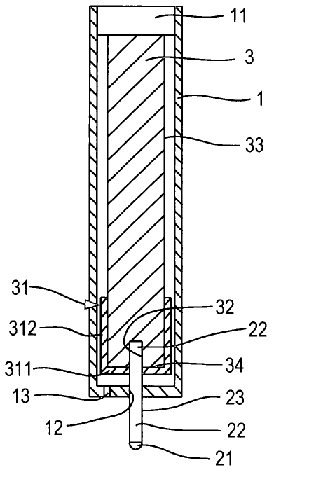

### BACKGROUND OF THE INVENTION

1. Field of the Invention

The present invention relates to writing instruments, drawing instruments and/or marking instruments and a reservoir for writing instruments, drawing instruments and/or marking instruments.

2. Description of the Related Art

Liquid repositories for writing instruments, drawing instruments and/or marking instruments with liquid repositories are generally known.

Devices of this type have at least one shaft, a liquid reservoir inserted therein and a writing wicking.

In order to obtain downstroke-capable instruments, a systematic selection of the individual components is necessary. For example, the component of the liquid reservoir has to be adjusted to varying ink systems, wherein the criteria ink flow, packing density, compatibility and, above all, also the discharge or ink containment behavior are taken into consideration. These are criteria in order to be able to evaluate a so-called drop test, flip test and storage test with the point facing downward. It has to be taken into account that already minor fluctuations in the quality of the reservoir lead to completely different behavior of the ink flow and containment capacity.

It is called a flip test when an instrument is mounted at the end facing away from the writing point and the point is pivoted back and forth around this mounting point in fast motions, so that the ink present in the reservoir of the instrument is concentrated in the point area.

U.S. Pat. No. 3,141,187 and German Patent 24 25 500, for example, disclose a fiber writer which consists mainly of shaft, wicking and reservoir. The reservoir mounted inside the shaft is connected with the wicking in a liquid conducting manner.

Disadvantageous in fiber writers constructed in this manner is that during the so-called flip test or falling test they discharge ink uncontrollably through the air compensation and/or through the wicking, so that inevitably contamination of the periphery occurs. In this connection, it is practically of no importance what material the capillary fiber reservoir or sinter reservoir is made of.

Furthermore, Japanese Patent 61-13357 discloses a fiber writing instrument in which through an appropriate design of the shaft geometry in the area of the point such an uncontrolled dripping through the writing point or through the ventilation duct located in the front part of the shaft is prevented. It is disadvantageous in this embodiment that such a shaft design is expensive on the side of the point, which does form a kind of collection tank, but a greater collection volume means a reduced size of the inserted liquid reservoir.

### SUMMARY OF THE INVENTION

Therefore, it is the object of the present invention to produce a reservoir for writing instruments, drawing instruments and/or marking instruments that are provided with liquid repositories which do not have the disadvantage described earlier and which at any time have a high leakage protection and are built in such a way that storage parameters and quality variations are only of minor importance.

Furthermore, it is an object of the present invention to produce a reservoir for instruments that guarantees a universal application and can nevertheless be constructed economically.

The object is met by providing a seal of the liquid reservoir on the side of the writing point. The sealing means of the writing point is penetrated by the writing wicking for the formation of a liquid control system.

The seal can be formed as a membrane, a foil and/or inherently stable collecting tank. In the case of a membrane it can be, for example, also a semi-permeable membrane.

In the case of a semi-permeable membrane the liquid reservoir can even be sealed over its entire surface, because at any time air can enter into the liquid reservoir and the liquid medium can be discharged through the above-described liquid control system.

It is of no significance in this connection how such a sealing means is mounted at or on the liquid reservoir. The sealing means can be plugged on, shrunk on, pasted on or mounted on in an immersion procedure. When the seal is formed by immersion, the end of the liquid reservoir is placed in a liquid medium, or possibly a molten bath, wherein, after taking out the reservoir from the bath, a layer builds as a sealing means and eventually hardens.

The above-mentioned sealing means types have in common that they are formed in a liquid retaining or liquid sealed manner, i.e., a liquid medium cannot be dispensed in an uncontrolled manner through the side of the liquid reservoir allocated to the writing point. The sealing means builds a kind of retention basin for collection of the liquid medium. The dimension, i.e., the size or the volume of the retention basin formed through the sealing means can be adjusted to the amount stored in the liquid reservoir.

It has been found to be as particularly advantageous that the use of the liquid reservoir according to the invention is accompanied by an important time saving in its selection in the course of the development activity, since as a result of the embodiment according to the invention, a considerably larger development range for inks, liquid reservoir and/or writing instrument is given. It has been proven as particularly advantageous that a greater amount of ink can be dosed when using a reservoir according to the invention, which reciprocates measurably in a significantly greater writing length.

Furthermore, the packing densities of repositories according to the invention can be specified variable.

The various features of novelty which characterize the invention are pointed out with particularity in the claims annexed to and forming a part of the disclosure. For a better understanding of the invention, its operating advantages, specific objects attained by its use, reference should be had to descriptive matter in which there are described preferred embodiments of the invention.

### BRIEF DESCRIPTION OF THE DRAWING

In the drawing:

The FIGURE of the drawing is a sectional view of a writing, drawing or marking instrument with a reservoir according to the present invention.

### DETAILED DESCRIPTION OF THE INVENTION

The FIGURE shows a writing instrument, drawing instrument and/or marking instrument with a liquid reservoir according to the invention including of a shaft 1, a writing wicking 2, an end cap 11 and a liquid reservoir 3.

The shaft 1 has a bore hole 13 for ventilation and a passage bore hole 12 for the writing wicking 2. The writing wicking 2 is connected to the liquid reservoir 3 via the wicking end 22 located opposite the writing point 21, so that the flow-capable application medium can be conducted from the liquid reservoir 3 through the wicking 2 to the writing point.

The liquid reservoir 3 has at its front side 34 facing the writing point a sealing means means 31, which is tray-shaped and consists of a frontal sealing means means 311 and a casing sealing means means 312 of the casing plane 33. The frontal sealing means means 311 has a contact opening or passage opening 32 for the writing wicking. It is essential in this embodiment that the outer surface 23 of the writing wicking 2 is tightly surrounded by the sealing means 31 so that in this area the collected liquid does not drip from the reservoir and escape unhindered through the ventilation bore 13 from the instrument and contaminate its surroundings. Excess ink or ink oversaturation in the area close to the point of the liquid reservoir can be caused, for example, by flipping, shaking or pivoting of the instrument.

The invention relates to a writing instrument, drawing instrument and/or marking instrument, wherein the instrument has at least one shaft, one liquid reservoir mounted therein and one writing wicking, wherein between the writing wicking and the liquid reservoir at least one contact point or contact area is formed for the conduction of the writing medium, wherein the at least one liquid reservoir, on the side facing the writing wicking, has an area with a sealing means, wherein the area with the sealing means covers the entire free front side of the liquid reservoir and wherein the area with the sealing means is formed extending at least over a partial area of the casing plane.

The section formed at least in a partial area of the casing plane with casing sealing means is formed as a contiguous and/or one-piece sealing means with the frontal sealing means. In this connection, the area with the sealing means is formed as a surface sealing means. The liquid reservoir consists of fiber material, sponge material, plastic spheres and/or of sintered plastic spheres. It is important in this connection that the writing wicking completely fills in the contact opening of the frontal sealing means.

Between the frontal sealing means and the outer surface of the writing wicking in the area of the contact opening a capillary slot can be formed.

The invention furthermore relates to a liquid reservoir for writing instruments, drawing instruments and/or marking instruments, wherein the reservoir is a capillary reservoir, wherein the liquid reservoir has a surface area which has a sealing area, wherein the area with sealing means extends at least over the entire front side of the liquid reservoir and wherein the area with sealing means extends at least over a partial area of the casing surface.

In addition, a further embodiment of the sealing means according to the invention is disclosed. In this embodiment the sealing means of the liquid reservoir consists of a highly capillary layer, which fills itself up with writing medium and which from that point on functions like a liquid-tight wall, because the retention force of the capillaries is very high and consequently the liquid cannot be dispensed uncontrollably through the liquid reservoir.

While specific embodiments of the invention have been shown and described in detail to illustrate the inventive principles, it will be understood that the invention may be embodied otherwise without departing from such principles.

I claim:

1. A writing instrument, drawing instrument and/or marking instrument, the instrument comprising at least one shaft, at least one liquid reservoir mounted therein and a writing wicking, wherein at least one contact point or contact area is formed between the writing wicking and the liquid reservoir for conducting the writing medium, wherein the at least one liquid reservoir has on a side facing the writing wicking an area with a sealing means, and wherein the area with the sealing means covers an entire free front side of the liquid reservoir, and wherein the area with the sealing means stretches at least into a partial area of the casing surface.

2. The instrument according to claim 1, wherein the sealing means is configured in a liquid retaining manner.

3. The instrument according to claim 1, wherein the area having a casing sealing means within at least a partial area of the casing surface is formed in a continuous and/or one-piece sealing means with the frontal sealing means.

4. The instrument according to claim 1, wherein the area with the sealing means is a as surface sealing means, and wherein the surface sealing means is present as membrane, foil and/or inherently stable retention tank.

5. The instrument according to claim 1, wherein the liquid reservoir is comprised of fiber material, sponge material, plastic globes and/or sintered plastic globes.

6. The instrument according to claim 1, wherein the writing wicking completely fills out a contact opening of the frontal sealing means.

7. The instrument according to claim 6, a capillary slot is formed wherein between the frontal sealing means and the outer surface of the writing wicking in the area of the contact opening.

8. A liquid reservoir for writing instrument, drawing instrument and/or marking instrument, the instrument comprising a capillary liquid reservoir wherein the liquid reservoir has a surface area with a sealing means, wherein the area of the sealing means covers at least the entire front side of the liquid reservoir, and wherein the area with the sealing extends at least into a partial area of a casing surface of the reservoir.
